(19) United States
(12) Patent Application Publication
(10) Pub. No.: US 2002/0082995 A1
(43) Pub. Date: Jun. 27, 2002

(54) Payment authorization system

(76) Inventor: Samuel H. Christie, IV, Cary, NC (US)

Correspondence Address: NORTEL NETWORKS, P O BOX 13828, RESEARCH TRIANGLE PARK, NC, 27709-3828, US

(21) Appl. No.: 09/749,842

(22) Filed: Dec. 27, 2000

(51) Int. Cl. G06F 17/60

(52) U.S. Cl. 705/44; 705/77; 705/67; 340/5.4

(57) ABSTRACT

Payment Authorization System. A system and a method are provided which add additional tests to the approval process for a financial account transaction. When an authorization request is received from a payee, the processing center sends an approval request to the account holder at a specified communication device, usually a wireless device. The user may approve or deny the transaction. The invention provides extra security for credit and other account transactions because the payment authorization service is transparent to payees, and because two independent items must be stolen or cloned in order to access an account.

### BACKGROUND

1. Field of the Invention

This invention relates to the field of electronic payment approval and authorization. More particularly, this invention relates an improved credit or similar account authorization system and method.

2. Description of the Problem

As society evolves, it continues to seek more convenient ways of paying for goods and services. The first system to replace the use of hard currency was based on drafts or “checks”, as we know them today. While checks have proved more convenient that carrying cash, the security of a check has sometimes been questionable in that any suitable document that specified the appropriate account and bore the account holder's signature could be legally presented as a draft on the account. In practice today, the use of pre-printed checks with security papers has provided a way to limit access to only those authorized.

The twentieth century saw the rise of the credit card and the credit card account. In the early days of credit cards, the user was required to present a physical card and sign a charge slip bearing an imprint of the card. More industrious criminals could forge a card, but it was difficult enough, and the convenience of credit cards was great enough, that the credit card industry flourished. Legal restrictions on the use of credit cards and on the liability of the consumer helped. Today, a credit card owner can dispute any use of a credit card when the charge appears on the credit account statement. The card issuer is then liable for most losses due to forgery. The use of the magnetic stripe reader has enabled card issuers to prevent forgery through increasingly elaborate security encoding schemes.

As the twentieth century progressed, telephonic mail order became popular and the physical presentation of credit cards was no longer required. Credit card fraud also increased. The advent of the Internet has added to the problem by making on-line shopping a pleasant experience and thereby encouraging greater use. As electronic commerce evolves, a continually growing percentage of the world's financial transactions will rely on the integrity of the ordering. Schemes for providing encrypted keys which are in use widely today prevent third parties from learning card specifics over the Internet, but dishonest individuals will still be able to obtain card numbers in more traditional ways and simply enter a stolen number on a web page as they order. Again, these losses are primarily felt by the card issuer, but the impact is societal in scope. The biggest threat to the consumer is the advent of debit cards and check cards which allow direct access to the consumer's bank account without an intervening step of verifying the charges.

The most often used external security measure imposed on the use of a credit account number today is direct, real-time authorization by a credit card processing center. A merchant's computer system is tied into a merchant network, which is in turn connected to a large data center operated by the credit card company or financial institution. When a charge is presented the appropriate transaction and account information is electronically transmitted to the data center and authorization is requested. Before authorizing the transaction, the data center computer system makes several checks to include whether the card has been lost or stolen as well as review and recount account histories to confirm recent, frequent use which may occur before a cardholder realizes the card is missing. What is needed is a way to enhance the security of financial account transactions, e.g., credit and debit accounts, by providing a way for the legitimate account holder to quickly and easily participate in the approval process whenever and wherever required.

### SUMMARY

The present invention reduces security risks by enhancing the authorization processing at the credit card processing center. An additional test is included in the list of verification tests performed to ensure the transaction is authorized. The test uses the power of modern, mobile telecommunications networks to allow instantaneous, real-time user participation in the authorization process.

According to one method of the invention, an account payment authorization service is provided by an account processing center. When an authorization request is received from a merchant containing transaction information, the processing center determines if the credit account holder has subscribed to the service. If so, an approval request is sent to the communication device that the user or account holder has specified. An approval response is then processed. In most cases, this involves processing an actual approval response when the user sends an approval response through the specified communication device. However, the response may include an assumed disapproval if there is no response within a specified time. The processing center then sends an appropriate authorization response back to the payee, who is usually a merchant. Essentially, the processing center treats this process as another of the various tests that are performed to determine if the charge should be authorized.

Note that the request from the payee or merchant and the correlative response is referred to as the “authorization” request and response, and the messages between the processing center and the user or account holder as the “approval” request and response. The transaction information can include the amount of the charge, the name of the payee, the account number or any other similar information needed to process the transaction. The specified communication device on which the user receives the approval request is typically a wireless device so that a user can approve transactions wherever they go. This can include a digital wireless phone, for example, with short text message capability, a wireless personal data assistant, or a laptop computer with a wireless modem. It can also, however, be a stationary device such as a telephone with text messaging capability or a desktop computer.

Additionally, while it is possible to use only the native capabilities of the specified communication device to implement the invention, it may also be desirable to provide specialized features and a special protocol for the device. The approval protocol can be implemented as a protocol extension to the normal messaging protocol in order to present the information (approval protocol request) to the user and send the response (approval protocol response) from the user without having to exchange details of how to format the information. The specialized features include hardware or software that enables the device to accept a specific response input, usually including buttons which read “approve” and “disapprove.” The protocol extension can also optionally include additional security features such as, for example, encryption.

Another feature is an account profile that is associated with the service of the invention. The user can update the account profile, for example, over a World Wide Web interface. The account profile is checked for each transaction and includes information such as a dollar amount below which the user does not want to be bothered for approvals.

The invention can be implemented in a network that includes an account processing center which is operable to process transactions in accordance with the payment authorization service that is provided by the invention. In one embodiment, the processing center is connected to a short message service (SMS) system which exchanges messages with the user's device. A merchant network is also connected to the processing center for receiving authorization requests from payees and sending back authorization responses.

The processing center where credit card processing takes place is typically a large data center with a large computer system or “mainframe” computer. The computer system includes a central processor, a system bus, one or more service processors, and a main memory. There are also input/output (I/O) controllers and large amounts of storage, as well as operator consoles. The specified communication device can take many forms, but typically includes a control block and memory which stores a computer program or “microcode” which operates the device. The control block includes a microprocessor or embedded controller. An input/output block typically includes a keyboard and display. The input/output block can also include keys or buttons for accepting a specialized response input. In the case of a wireless device, an RF unit and antenna allow communication with a wireless network.

The invention provides exceptional security for credit account transactions because the extra security provided is transparent to payees and merchants. In addition, two seemingly independent and unrelated items must be stolen or cloned in order for a thief to get access to a user's account: the credit account number, and the specified or currently activate approval device.

### BRIEF DESCRIPTION OF THE DRAWINGS

FIG. 1 is a schematic block diagram of a credit authorization system according to the present invention;

FIG. 2 is a flowchart showing the method of operation of the authorization system of FIG. 1;

FIG. 3 is a block diagram of a computer system at the processing center that is used to implement the present invention;

FIG. 4 is a flowchart showing the method of operation of a wireless device used to respond to an authorization request in accordance with the present invention; and

FIG. 5 is a schematic block diagram of a wireless device used to implement the present invention.

### DETAILED DESCRIPTION

The present invention provides a system and method for payment authorization. An account user or credit card holder can subscribe to the service to provide more secure credit based transactions. The service uses a communication device specified by the user. The device is typically portable and can include, for example, a two-way pager, cellular telephone with short message service (SMS) capability, a laptop computer or a personal digital assistant. However, the preceding examples are intended to be illustrative, rather than limitations, as any personal communication device, wireline or wireless, can also be used such as, for example, a landline telephone or PC. Through the service, the credit card holder can instruct his or her financial institution not to authorize use of his credit card without electronic authorization via the specified communication device. In doing so, the cardholder specifies to the institution an address for the communication device, e.g. phone number, pager number, IP address, and the like.

It should be noted that the present invention works with any type of user money account which can be electronically accessed to pay for goods and services. Thus, while credit card accounts are referred to throughout the following discussion, the invention also works with checking accounts, debit accounts, and other types of financial accounts, whether or not a physical “card” is associated with the account.

Consider, for example, using a credit card to purchase a meal at a restaurant. The user has registered for the service authorization implemented according to the present invention and uses a two-way alphanumeric pager as the specified communication device. The restaurant enters the card number into the system to begin processing for payment, such as, for example, using a card swipe machine. The authorization request containing the appropriate transaction information is sent to the card issuing institution for authorization. As previously discussed, the card processing center portion of the institution runs several tests to verify non-fraudulent card use, to include the approval according to the present invention.

The processing center determines that the cardholder subscribes to the authorization service and has provided information for a currently specified communications device, in this case a pager. The processing center sends a message to the cardholder's pager and the relevant transaction information appears on the screen. The cardholder, having desired to make the transaction, then uses the two-way capability of the pager to immediately approve the transaction.

Now, suppose a server at the restaurant writes down the cardholder's credit card number, or captures it on a pocket-sized, card swipe device for later retrieval. Afterwards, the server visits an on-line merchant and enters the stolen card number on a World Wide Web form to pay for the purchase. When an authorization request for this transaction is sent to the processing center for the bank, an approval request is automatically sent to the cardholder as described above. The cardholder, surprised by the approval request, has an opportunity to deny the transaction. Thus, the charge request is intercepted and stopped at the source, preventing the fraud from having significant financial consequences. Meanwhile, the institution has been alerted to the potential fraudulent use of the card and can react quickly.

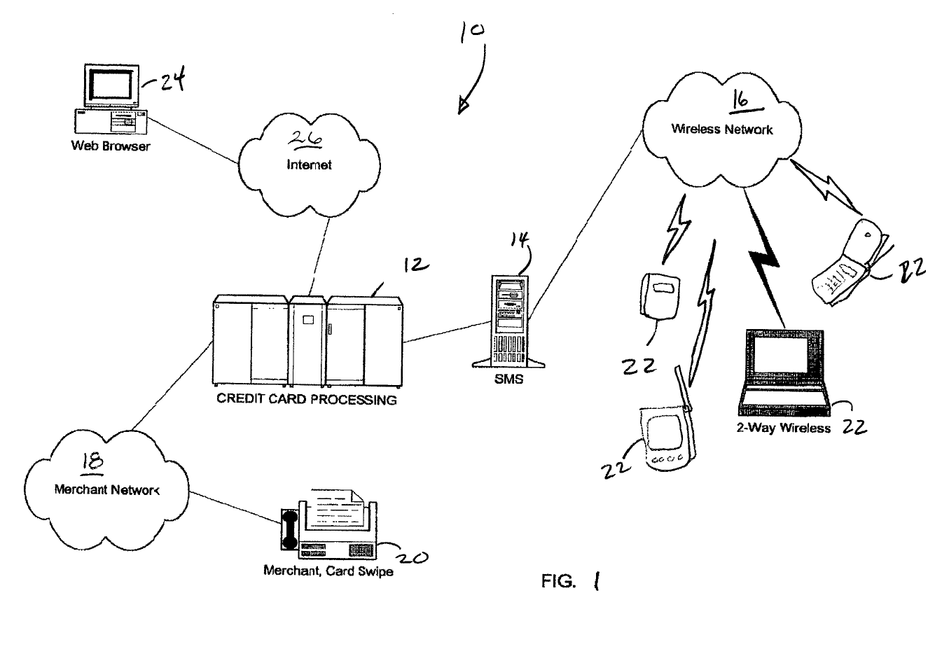

Authorization system 10, FIG. 1, includes programmed computer system 12 where account processing is performed. Computer system 12 is typically a large system or “mainframe” which operates a large data center. Computer system 12 is connected to a short message service (SMS) system 14. SMS system 14 is typically implemented as a server or system that interfaces to a wireless network 16. However, SMS system 12 can also be integrated into computer system 12. SMS system 14 can also be operated either by the financial institution or the wireless provider. In this example, authorization requests are received via a merchant network 18. Transaction information is generated by a card swipe device 20 or other means for entering credit card information, e.g., audibly over the handset. For security, merchant network 18 is typically implemented by a direct dial-up connection, or a dial-up connection with an intervening private digital network (not shown), such as a packet switched network. Also in this example, wireless network 16 transports approval requests and responses between SMS system 14 and a two-way wireless device 22, e.g. pager, laptop, PDA or cell phone.

A PC or workstation 24 is shown connected to processing center computer 12 via a worldwide web interface 26, for implementation of one of the optional features of the invention. Through this connection, a subscriber to the service can maintain an account profile. This profile contains specific parameters for the service as applied to the particular account and can be updated by the user over a World Wide Web interface, or possibly through software supplied to the user specifically for the purpose. The account profile contains information such as a dollar amount below which approval requests are not needed, list of approval devices, currently active approval device. This information can be maintained, for example, on a presence server that is readily accessible by the user in order to make any necessary updates.

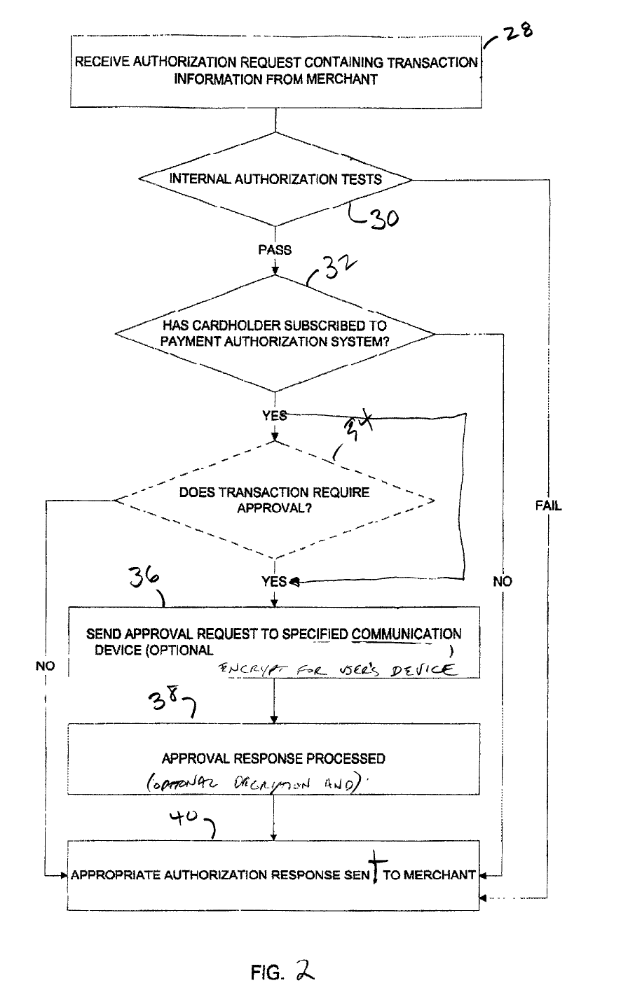

The method performed at processing center 12 to implement the present invention is shown in FIG. 2. An authorization request is received at the processing center from a payee (Block 28), typically a merchant. This authorization request is transmitted to the processing center over the merchant network and contains transaction information such as charge amount, card type, account number, etc. The standard tests and/or authorization checks are performed in response to the request (Block 30). If these tests fail, a failure response is sent to the merchant immediately. If these tests are passed, a determination is made whether the credit cardholder has subscribed to the payment authorization service (Block 32). If not, a response is sent immediately to the merchant. If it is determined that the card holder does subscribe, an optional check of the user profile can be made to determine if approval is required for this particular transaction (Block 34), shown in phantom.

Otherwise, once it is determined that a cardholder subscribes to the service (Block 32) an approval request is sent to the specified communication device (Block 36). As will be discussed in more detail below, this request can be simple and use only native capabilities of a standard communication device, or it can further include an approval protocol. If an approval protocol is used optional security checks can be included. The cardholder then either approves or declines (Block 38) the authorization request through the communication device 22/26 (FIG. 1). An approval response is then processed. In most cases this is a response from the specified communication device, optionally using an approval protocol. However, this step may include assuming a default response according to a set of predefined rules for one for more vendor types such as, for example, a default approval for predefined dollar amounts for purchases at gas stations, or denial if a specified period of time has elapsed, or other processing based in the optional user profile. Finally, an appropriate authorization response is sent to the payee or merchant (Block 40). As with current systems, this authorization response includes an authorization number for future reference.

One method according to the present invention is preferably executed on a general purpose, programmed computer platform at processing center 12 (FIG. 1). This computing platform can be of any size or type. Mainframe computers provide significantly more connectivity of peripherals and significant on-line storage capacity, which is particularly useful in financial applications. Mainframes also offer greater reliability, information processing throughput, and data security. A suitable mainframe architecture may include, for example, IBM's System 360/370 architecture, most recently upgraded to the System 390.

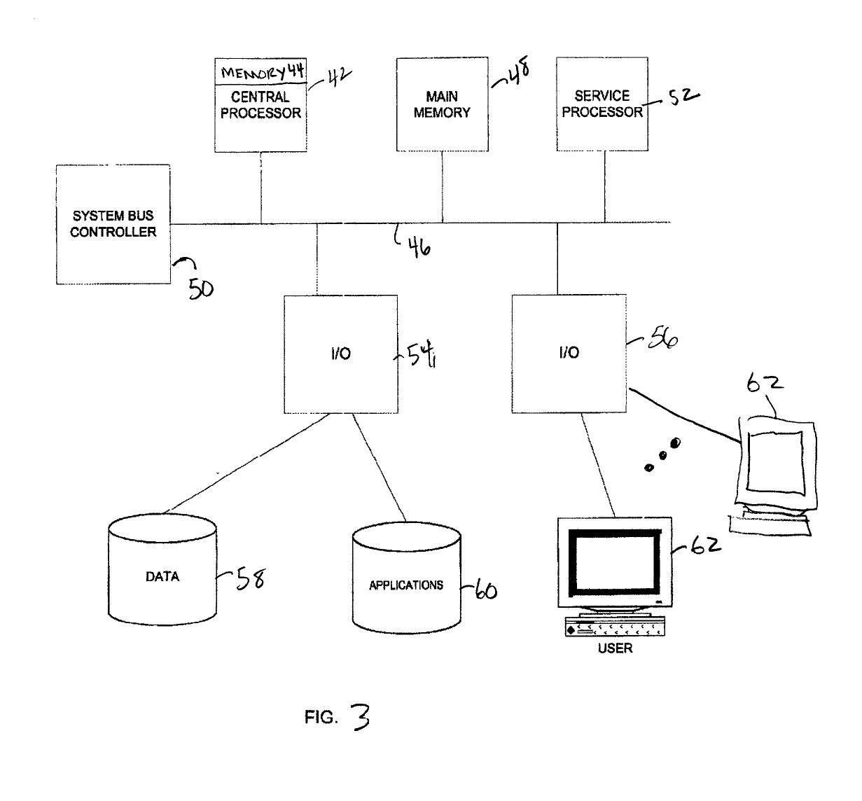

FIG. 3 represents a block diagram of a typical single or “uni” processor mainframe computer system. Central processor complex 42 forms the heart of the system and includes a high-speed cache memory 44 for fast access to recently used data. Central processor 42 controls the execution of the method of the present invention. Central processor 42 is coupled to system bus 46 for access to main memory 48. Access to system bus 46 is controlled by requests and grants, which are processed by system bus controller 50. Service processor 52, also coupled to system bus 46, provides an operator console function for configuring the system and controlling the operational aspects of the system.

A key distinguishing feature of the mainframe is that it supports multiple, high throughput, input/output or “I/O” processors or complexes, which can be local or distributed. In the simplified diagram of FIG. 3 these are shown as I/O processors 54 and 56. Processors 54/56 offload I/O tasks from central processor 42 and transfer information to and from main memory 48 through direct access memory channels. In this example I/O processor 54 is connected to storage devices 58 and 60, which store data and application programs associated with the functions of card processing center 12 (FIG. 1), including the implementation of the present invention. I/O processor 56 is connected to user terminals 62 such as a desktop computer. Terminals 62 may be local, or connected through a remote network, for example, the merchant network of the present invention.

As previously discussed, the present invention makes use of two way message transmission service currently offered by numerous telecommunication providers. The processing center includes or is connected to two way message transmission service system 14 (FIG. 1). Two way message transmission service system 14 converts the approval request and response messages to and from a format that can be exchanged with the telecommunication provider for use in two way message transmission service messages. Two way message transmission service system 14 is a store and forward system in which messages from a sending party are forwarded to a receiving party through a two way message transmission service center (not shown), which is part of the existing telephone network (not shown). In the case of wireless network 16 it is part of a mobile switching center. Two way message transmission service messages may originate or terminate at any mobile, wireless, or wireline device 22 (FIG. 1), including mobile handsets, two-way pagers, wireless networked personal digital assistants, conventional wireline telephones, and desktop, or laptop personal computers. Two way message transmission service permits the sending of text, numeric, or alphanumeric messages.

As an illustrative example, short message service (SMS) will be discussed as it is implemented in the GSM (global system for mobiles) wireless network. Implementation in other mobile phone systems and in two-way, digital paging systems is very similar. In GSM, SMS messages can be up to 160 characters in length. The messages are sent through the network's signaling path and so may be sent and received simultaneously with GSM voice, data and fax calls.

As previously discussed, the present invention can be implemented using the current, native capabilities of two-way wireless devices. Most GSM phones have built-in functionality that allows a user to automatically answer a received message by entering a character, pushing a button, or navigating a menu. In this case, the approval message would be received as an SMS message at the GSM phone and the user may hear the phone beep, vibrate or otherwise signal the user who may see a message as follows:

>Charge approval: Smithville Diner-$34.50. Respond “1” to approve or “2” to disapprove<

Send response? (“Enter” for yes or “Clear” for no)

The last line is automatically presented to the user as part of the phone's normal function. At this point, the user presses enter and gets a message from the phone:

Type response and press “Enter” to send. On some phones this message is generated only after navigating a “response menu.” In any case, to approve the user presses “1” and then “Enter”. To disapprove, the user presses “2” and then enter. The approval response is sent back to the processing center and the transaction is complete from the user's perspective.

While the above-described system works well, user interaction according to the invention can be made even simpler and potentially more secure through the use of a communication device that includes specialized hardware and software for implementing the invention. The hardware includes keys or soft key functions for “approve” and “disapprove” and possibly others which are related to the payment authorization service of the invention. The software includes an approval protocol for more efficiently transmitting and receiving transaction information; microcode for automatically formatting and presenting the transaction information, eliminating the need for text like, “Respond ‘1’ to approve or ‘2’ to disapprove”; and microcode for detecting the user's response. The software also optionally includes enhanced security features. Such communication devices would make use of the service less obtrusive to users. Financial institutions could encourage use by providing devices and/or prepaid wireless service in return for user participation.

A special purpose approval protocol can be implemented to enhance the present invention. Such a protocol can have several embodiments. One embodiment uses IP enabled wireless terminals. Such devices typically support Java Remote Method Invocation (RMI) and the IPSec protocol for end to end message encryption and device authentication and are readily apparent to those skilled in the art. A wireless device can include a Java Bean that implements the user interface request for approval.

Alternatively there can be included a secure socket and web server push model. The user's device executes a web client using a standard protocol (WAP, HTML, . . . ). Where the client device is not capable of Java RMI or IP Sec, a special purpose protocol can be implemented. The protocol typically contains two messages: one for requesting approval and one for either accepting or rejecting the request. This could, for example, include an extension to the native messaging protocols for the device in question such as GSM's SMS. In this case the existing protocol is extended to identify the special context of the message. The message body provides structured fields for the relevant information and is well known in the art.

Further, the entire message can be encrypted using the mechanisms of the native protocols, however, the message body itself might use digital signature and encryption technology if necessary and readily apparent to those skilled in the art.

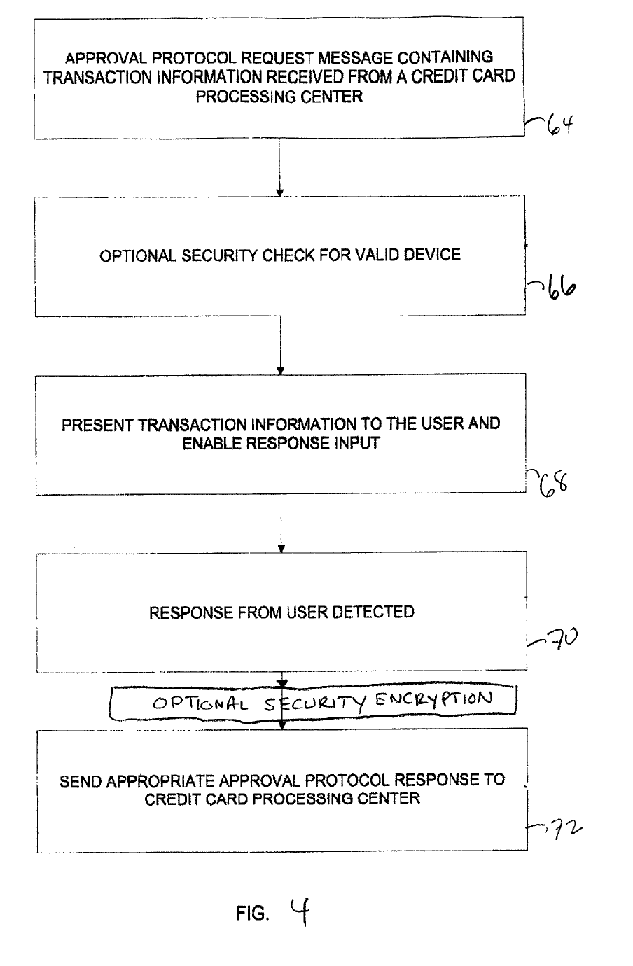

FIG. 4 illustrates the method of a personal communication device which specifically implements the invention as described above. An approval protocol request message containing the appropriate transaction information is received from the credit account processing center (Block 64). An optional security check, as described above, can be performed (Block 66). Transaction information is then presented to the user for approval (Block 68). The device detects a response from the user (Block 70) by the user pressing one of an approval or disapproval button or soft key. It is, however, also possible to implement this feature using voice response hardware or software. An appropriate approval protocol response is sent back to the processing center through the network (Block 72) based on the user's response which was detected at (Block 70).

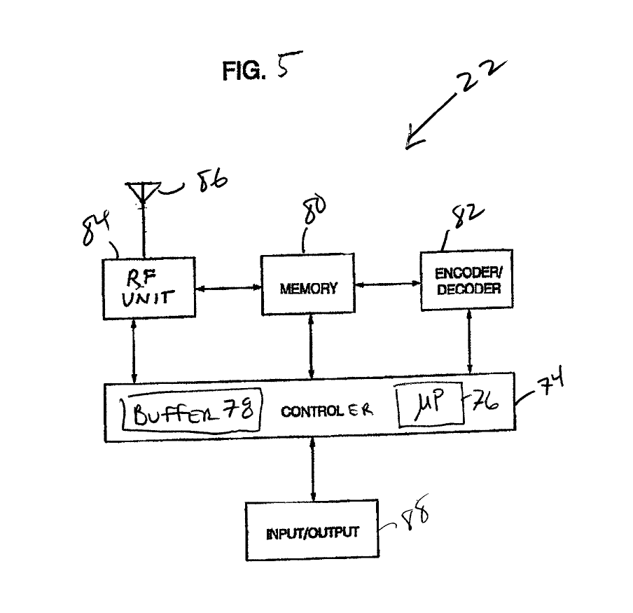

A personal communication device 22, FIG. 5, which can be used to implement some aspects of the invention includes of a controller 74, which includes a microprocessor 76, that controls the operation of device 22. In the case of a pager or phone, microprocessor 76 is typically an embedded controller, digital signal processor, or some combination of the two. Controller 74 also includes a buffer 78 to store displayed messages and detected inputs. In the case of a personal computer system this can include the central processing unit (CPU). A memory 80 includes at least a read-only memory (ROM) which stores computer code that operates device 22. Controller 74 uses this code to perform the operations required by the user, including implementing the invention. Memory 80 can also include “on-board” random-access memory (RAM) used to store, for example, a personal telephone directory, saved text messages, and similar information. An Encoder/decoder 82 encodes and decodes text messages. In some cases Encoder/decoder 82 can be integrated into controller 74. If device 22 is a wireless device, RF unit 84 and antenna 86 provide communication with wireless network 16 (FIG. 1).

An Input/output block 88 includes the screen display, keypad, or keyboard and associated electronics. Where device 22 includes a pager or wireless phone, Input/output block 88 includes input keys.

Device 22 as described above can take many forms and be designed many different ways. If the device also has voice capability, a microphone, speaker, and a compressor/decompressor or “CODEC” is included. CODEC's use sophisticated compression algorithms to encode and decode analog voice so it can be carried digitally and are well known in the art. With increasing integration densities, many of the functions illustrated above can be combined in a single semiconductor processor which forms the controller 74 of the device.

The present invention has been described as specific embodiments which provide for a payment authorization service for enhanced financial account security: One of ordinary skill in the networking and computing arts will quickly recognize that the invention has other applications in other environments. In fact, many embodiments and implementations are possible. The following claims are in no way intended to limit the scope of the invention to the specific embodiments described.

What is claimed is:

1. A method of processing a transaction in association with a payment authorization service, the method comprising the steps of:
(a) receiving an authorization request regarding a user's account containing transaction information;
(b) sending an approval request to a user;
(c) receiving an approval response from the user; and
(d) sending an authorization response to the payee.

2. The method of claim 1 further comprising the step of verifying that a user subscribes to an authorization service.

3. The method of claim 1 in which the step of sending an approval request to a user includes sending the request to a specified communications device.

4. The method of claim 1 further comprising the step of examining an account profile and determining if the transaction requires authorization prior to sending the approval request.

5. The method of claim 1 in which the approval request is formatted according to an approval protocol.

6. The method of claim 5 in which the request is sent and received using a two way message transmission service.

7. The method of claim 4 in which the approval request is formatted according to an approval protocol.

8. The method of claim 7 in which the request is sent and received over a wireless network using a two way message transmission service.

9. A programmed computer system having one or more network connections, the programmed computer system operable to process transactions for providing a payment authorization service by performing the steps of:
(a) receiving an authorization request containing transaction information from a payee regarding a user's account;
(b) sending an approval request to a user;
(c) processing an approval response from the user; and
(d) sending an authorization response to the payee.

10. The computer system of claim 9 further comprising the step of verifying that a user subscribes to an authorization service.

11. The computer system of claim 9 in which the step of sending an approval request to a user includes sending the request to a specified communications device.

12. The computer system of claim 9 which further includes the step of examining an account profile and determining if the transaction requires authorization prior to sending the approval request.

13. The computer system of claim 9 in which the approval request is formatted according to an approval protocol.

14. The computer system of claim 13 in which the request is sent and received over a wireless network using a two way message transmission service.

15. The computer system of claim 9 wherein the approval request is formatted according to an approval protocol and are further sent and received over a wireless network using a two way message transmission service.

16. A computer program product for enabling a computer system to process transactions for providing a payment authorization service, the computer program product having a media with a computer program embodied thereon, the computer program comprising:
(a) computer program code for receiving an authorization request containing transaction information from a payee regarding a user's account;
(b) computer program code for sending an approval request to a user;
(c) computer program code for receiving an approval response from the user; and
(d) computer program code for sending an authorization response to the payee.

17. Apparatus for processing transactions in conjunction with a payment authorization service, the apparatus comprising:
(a) means for receiving an authorization request containing transaction information from a payee regarding a user's account;
(b) means for sending an approval request to a user;
(c) means for receiving an approval response from the user; and
(d) means for sending an authorization response to the payee.

18. In a communication device, a method of processing transactions in conjunction with a payment authorization service, the method comprising the steps of:
(a) receiving, from an account processing center, an approval protocol request message containing transaction information;
(b) presenting the transaction information to a user;
(c) detecting a response from the user; and
(d) sending an approval protocol response to the account processing center.

19. Apparatus, which is operable to process messages according to an approval protocol, the apparatus comprising a memory containing computer program code for causing the system to perform the steps of:
(a) receiving, from an account processing center, an approval protocol request message containing transaction information;
(b) presenting the transaction information to a user;
(c) detecting a response from the user; and
(d) sending an approval protocol response to the account processing center.

20. The apparatus of claim 19 further comprising a radio frequency (RF) unit communicating with the account processing center over a wireless network.

21. A network for processing transactions for providing a payment authorization service, the network comprising:
(a) a programmed computer system operable to process transactions in conjunction with the payment authorization service by sending an approval request to a user and processing an approval response from the user;
(b) a two way message transmission service connected to the programmed computer system for exchanging the messages with the user over a wireless network; and
(c) a merchant network connected to the programmed computer system for receiving authorization requests and transaction information.

22. The network of claim 21 further comprising a two way message transmission service connected to the programmed computer system for exchanging the messages with the user over a wireless network.

23. The network of claim 21 in which the programmed computer system further includes a user account profile.

24. The network of claim 23 in which the programmed computer system is connected to the internet for providing the user access to the account profile.

25. The network of claim 22 in which the messages exchanged by the two way message transmission service are formatted according to an approval process.
